(19) United States
(12) Patent Application Publication
(10) Pub. No.: US 2019/0034821 A1
(43) Pub. Date: Jan. 31, 2019

(54) Forecasting Run Rate Revenue with Limited and Volatile Historical Data Using Self-Learning Blended Time Series Techniques

(71) Applicant: Dell Products L.P., Round Rock, TX (US)

(72) Inventors: Rajkumar Dan, Bangalore (IN); Arnab Chowdhury, Bangalore (IN)

(73) Assignee: Dell Products L.P., Round Rock, TX (US)

(21) Appl. No.: 15/659,904

(22) Filed: Jul. 26, 2017

(51) Int. Cl. G06N 99/00; G06N 7/00

(52) U.S. Cl. CPC G06N 99/005; G06N 7/005

(57) ABSTRACT

A system, method, and computer-readable medium are disclosed for manufacturing and configuring an information handling system, comprising: generating a first level forecast prediction, the first level forecast prediction being based upon seasonal factors and a trend component; generating a second level forecast prediction, the second level forecast prediction being based upon an average error between current time period revenue data and a plurality of previous time periods revenue data; generating a third level forecast prediction, the third level forecast prediction being based upon a remaining portion of a particular time period and data relating to an already completed portion of the particular time period; generating a final forecast prediction, the final forecast prediction being based upon the first level forecast prediction, the second level forecast prediction and the third level forecast prediction; and, adjusting inventory used for manufacturing and configuring the information handling system based upon the final forecast prediction.

### BACKGROUND OF THE INVENTION

### Field of the Invention

The present invention relates to information handling systems. More specifically, embodiments of the invention relate to forecasting run rate revenue with limited and volatile historical data using self-learning blended time series techniques.

Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to use information handling systems to track and manage sales information such as a sales pipeline to achieve planned targets. Tracking and managing sales information can enable a company to achieve consistent performance year over year. Tracking and managing sales can be especially important for companies that manufacture and/or supply goods and/or services. One example of a tool that information handling systems use to track and manage sales information is the customer relationship manager (CRM) tool such as that available from Salesforce.com, Inc.

### SUMMARY OF THE INVENTION

A system, method, and computer-readable medium are disclosed for manufacturing and configuring an information handling system, comprising: generating a first level forecast prediction, the first level forecast prediction being based upon seasonal factors and a trend component; generating a second level forecast prediction, the second level forecast prediction being based upon an average error between current quarter revenue data and a plurality of previous quarters revenue data; generating a third level forecast prediction, the third level forecast prediction being based upon a remaining portion of a particular time period and data relating to an already completed portion of the particular time period; generating a final forecast prediction, the final forecast prediction being based upon the first level forecast prediction, the second level forecast prediction and the third level forecast prediction; and, adjusting inventory used for manufacturing and configuring the information handling system based upon the final forecast prediction.

In certain embodiments, manufacturing and configuring the information handling system is based upon performing a forecasting operation. In certain embodiments, the forecasting operation forecasts run rate revenue with limited and volatile historical data using self-learning blended time series techniques. In certain embodiments, the forecasting operation includes a multi-step approach which uses blended time series techniques to achieve robust, consistent and accurate prediction at a granular level. In certain embodiments, the multi-step approach provides an end to end process of prediction. Such a multi-step approach, addresses the issue of missing data, identifies outliers, decomposes trend and seasonality, extrapolates pattern, assigns weight to immediate past revenues, and incorporates impact of week to date (WTD) revenue of a current quarter. A forecast is generated using the results trend and seasonality decomposition, recent impact adjustment and current quarter weeks to date revenue impact. In certain embodiments, the forecasts are synthesized using weights assigned from individual prediction error to arrive at final prediction. The forecast operation provides a significant improvement in accuracy over the known forecast techniques and also over standard time series models. The forecast operation is universally suited to other use cases.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a forecasting environment.

FIG. 3 shows a block diagram of a forecasting system.

FIG. 4 shows a flow chart of the operation of the forecasting operation.

FIG. 5 shows an example of the effect of the logarithmic transformation.

FIG. 6 shows an example of a result when statistical techniques are applied to identify outliers and missing values.

FIG. 7 shows an example of a first level of revenue forecast using the RR revenue forecasting model of the forecasting operation.

FIG. 8 shows an example of a second level of revenue forecast using the RR revenue forecasting model of the forecasting operation.

FIG. 9 shows an example of a third level revenue estimate using the run rate revenue forecasting model.

FIG. 10 shows an example of a final prediction using the run rate revenue forecasting model.

FIG. 11 shows an example of a comparison of the final run rate prediction vs. actuals data.

### DETAILED DESCRIPTION

Various aspects of the present disclosure include an appreciation that accurate forecast of revenue is extremely important for managing a sales pipeline of an organization. Various aspects of the present disclosure include an appreciation that managing a sales pipeline can then aid in inventory management as well as product manufacture and configuration.

Various aspects of the present disclosure include an appreciation that a known moving average methodology is unable to capture seasonality that exists in run rate revenue data. As a result, the prediction results suffer from lack of consistency and robustness. Certain improvements such as standard time series methodology can improve accuracy, but the prediction can drift in presence of limited and volatile historical data.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

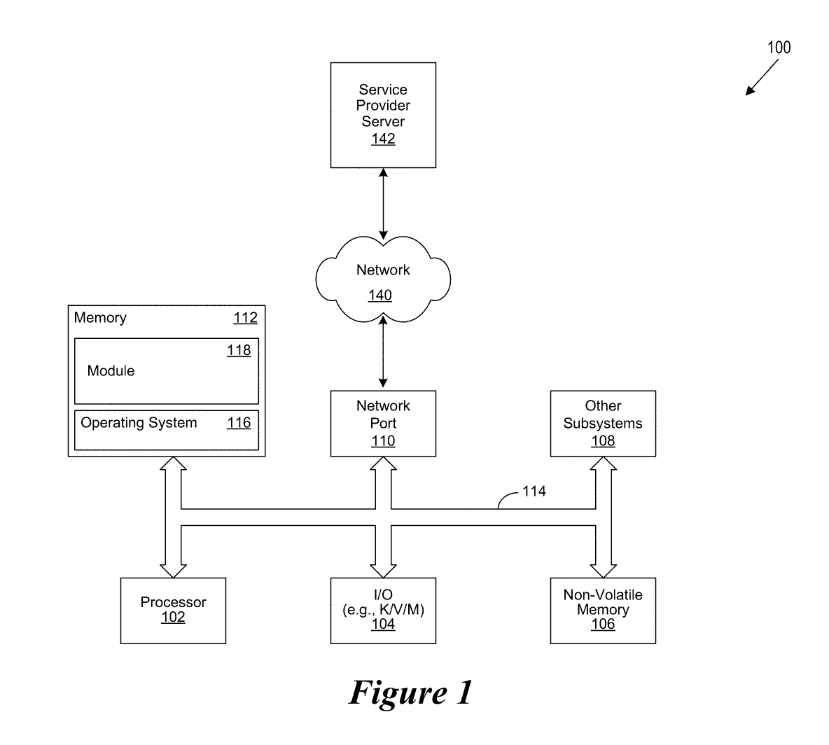

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise forecasting system 118.

The forecasting system 118 performs a forecasting operation. The forecasting operation improves processor efficiency (and thus the efficiency of the information handling system 100) by quickly and accurately providing a forecast from multiple disparate data sources.

As will be appreciated, once the information handling system 100 is configured to perform the forecasting operation, the information handling system 100 becomes a specialized computing device specifically configured to perform the forecasting operation and is not a general purpose computing device. Moreover, the implementation of the forecasting operation on the information handling system 100 improves the functionality of information handling system and provides a useful and concrete result of quickly and accurately providing a forecast from multiple disparate data sources

In certain embodiments, the forecasting operation forecasts run rate revenue with limited and volatile historical data using self-learning blended time series techniques. In certain embodiments, the forecasting operation includes a multi-step approach which uses blended time series techniques to achieve robust, consistent and accurate prediction at a granular level. In certain embodiments, the multi-step approach provides an end to end process of prediction. Such a multi-step approach, addresses the issue of missing data, identifies outliers, decomposes trend and seasonality, extrapolates pattern, assigns weight to immediate past revenues, and incorporates impact of week to date (WTD) revenue of a historical time period. A forecast is generated using the results trend and seasonality decomposition, recent impact adjustment and current quarter weeks to date revenue impact. In certain embodiments, the forecasts are synthesized using weights assigned from individual prediction error to arrive at final prediction. The forecast operation provides a significant improvement in accuracy over the known forecast techniques and also over standard time series models. The forecasting operation is universally suited to other use cases.

Such a forecasting operation is simple and scalable. More specifically, the forecasting operation comprises a simple, easy to implement methodology without compromising on techniques. The multi-step, end to end process addresses the problem of missing and negative revenue data, identifies and adjusts for outliers in the estimation methodology, focuses on applying and combining multiple techniques to come up with final prediction. Overall, the forecast operation uses the time series analysis, regression techniques and modelling in presence of limited and volatile data. The whole solution is scalable at a granular level and thus is useful for the business to implement in pipeline sufficiency reports.

Such a forecasting operation is adaptable and discoverable. More specifically, the forecasting operation provides a self-learning solution that is adaptable to constant changes in business scenarios. The forecasting system includes an architecture which is designed to not only capture overall historical pattern but also to account for recent impacts, whether the impacts are from previous time period (e.g., quarter) revenue data and/or current time period revenue data. In certain embodiments, the forecasting operation adjusts for the impacts via a voting method based on the predictability gaps. In certain embodiments, the predictability gaps are used as weights when performing the forecasting operation.

Such a forecasting operation increases the performance of a forecasting system while reducing prediction error. For example, in one implementation the Mean Absolute Prediction Error (MAPE) for overall worldwide commercial businesses was reduced from 7% (using a known forecast methodology) to 1% (using present forecast methodology). This performance is achieved using existing data extracts only and no additional sources are needed.

Such a forecasting operation is repeatable. The forecasting operation is repeatable in other areas to forecast using time series data. The forecasting operation can also be applied for bidding prediction (i.e., prediction where there is an offer and acceptance, often present with larger orders) with little customization.

Such a forecasting operation is extendable to other business objectives. For example with little or no modification the forecasting operation can organize and manage commit numbers of individual contributors on a weekly basis into a centralized system. The forecasting operation can be leveraged to provide revenue guidance (e.g., an expected revenue range) as the forecast operation can quickly calculate the expected revenue and its volatility.

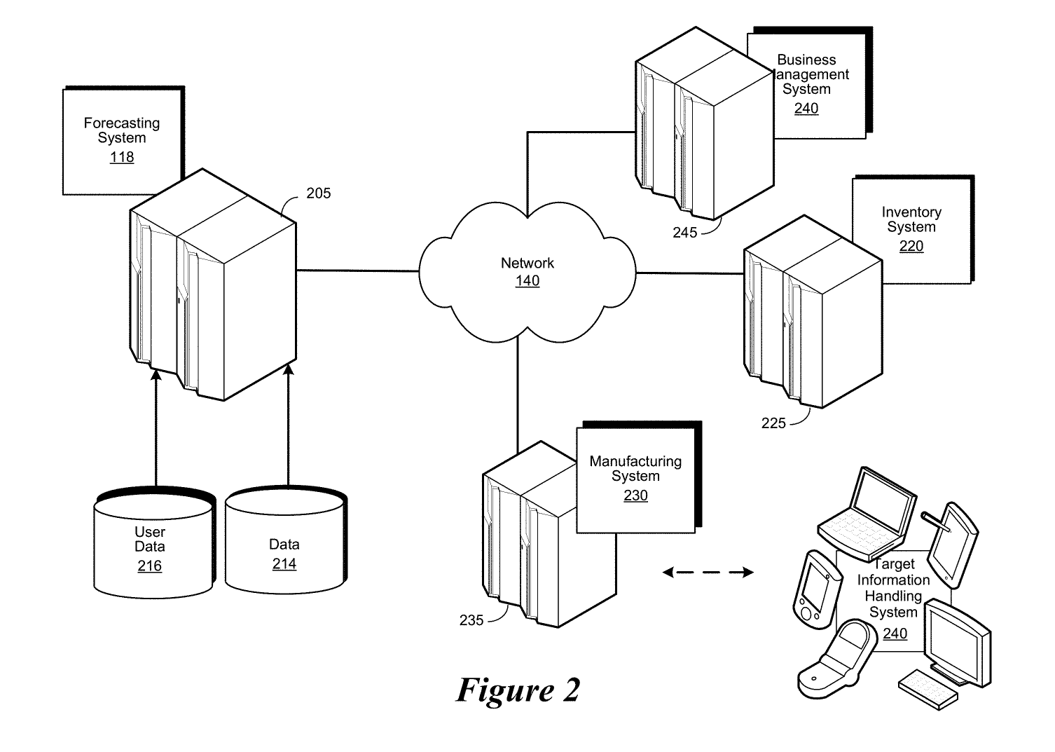

FIG. 2 shows a block diagram of a forecasting environment 200. More specifically, the forecasting environment 200 includes a forecasting server 205 executing the forecasting system 118, an inventory server 215 executing an inventory system 220 a manufacturing server 225 executing a manufacturing system 230 and a business management system (BMS) 240 executing on a business manufacturing system server 245. In various embodiments, the forecasting system 118 is implemented on the forecasting server 205 to perform a forecasting operation. In various embodiments, the inventory system 220 is implemented on the inventory server 215 to perform an inventory operation. In various embodiments, the manufacturing system 230 is implemented on the manufacturing server 225 to control the manufacture and/or configuration of a product such as an information handling system 240. In various embodiments, the BMS 240 is implemented on the BMS server 245 to provide business intelligence operations. In certain embodiments, the business intelligence operations include data modeling operations. In certain embodiments, results of the forecasting operation are provided to the BMS 240 to enable the BMS 240 to take into account forecasts provided by the forecasting operation when performing the business intelligence operations. In various embodiments, the manufacturing system 118, the inventory system 220, the manufacturing system 230 and the BMS 240 execute on hardware processors on their respective servers to perform their respective operations.

In various embodiments, the forecasting system 118, the inventory system 220, the manufacturing system 230 and the BMS 240 exchange information through the use of a network 140. In certain embodiments, the network 140 may be a public network, such as the Internet, a physical private network, a wireless network, a virtual private network (VPN), or any combination thereof. Skilled practitioners of the art will recognize that many such embodiments are possible and the foregoing is not intended to limit the spirit, scope or intent of the invention. In various embodiments the information handling system 205 may receive information from one or more data repositories 212, 214, either directly or via the network 140.

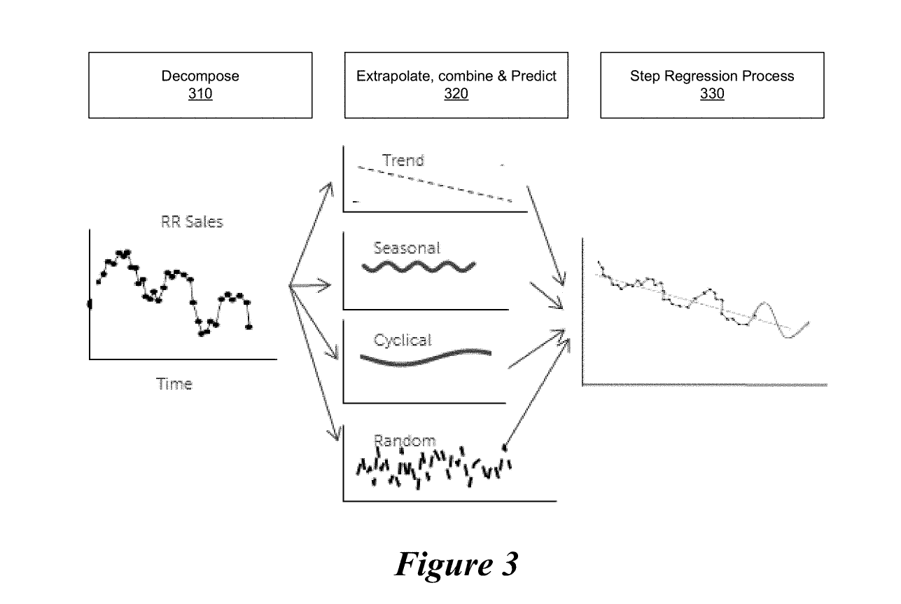

Referring to FIG. 3, a block diagram of a forecasting system 300 is shown. More specifically, the forecasting system includes a decompose module 310, an extrapolate, combine and predict module 320 and a step regression process module 330. The decompose module 310 decomposes historical run rate sales revenue data. The extrapolate, combine and predict module 320 extrapolates, combines and predicts based upon the run rate sales revenue data as well as trend data, seasonal data and weekly pattern data (which can present itself as random data). The extrapolate, combine and predict module 320 provides three estimated revenue forecast levels. The step regression process module 330 applies a three step regression process based upon the three estimated revenue forecast levels provided by the extrapolate, combine and predict module 320.

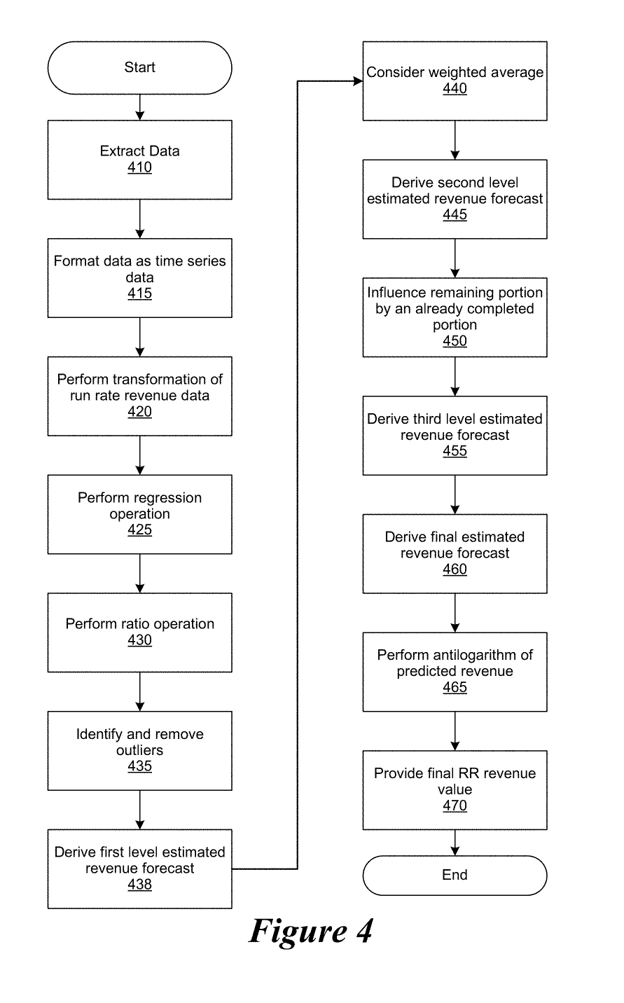

Referring to FIG. 4, a flow chart of the operation of the forecasting operation is shown. More specifically, when initiating a forecasting operation, data for performing the forecasting operation is extracted from a data repository at step 410. In certain embodiments, the data repository includes a relational database management system such as that available from Teradata Corp. Next at step 415, the data is formatted as time series data. In certain embodiments, the time series data includes weekly time series data. In certain embodiments, the formatting includes separating the data at a granular level. In certain embodiments, the granular level includes a business unit level, a type level, an area level, a product level, and a line of business level. Next at step 420, a transformation is performed on run rate (RR) revenue data. For the purposes of this disclosure, run rate revenue refers to revenue relating to smaller transactions (e.g., orders or purchases) which lie below a predetermined threshold. Transactions above the threshold are considered bidding transactions. In the present environment information relating to bidding transactions (e.g., revenue data) are captured at an individual level while information relating to run rate type transactions are captured at an aggregated level based on past historical time periods. The transformation addresses skewness in data if it exists and linearizes the data. In certain embodiments, the transformation includes a logarithmic transformation. Next, a regression operation is performed on the transformed RR revenue data at step 425 such that the transformed RR revenue data is regressed on time. In certain embodiments, the existence of missing values, negative revenue values and other aberrations are automatically excluded from the regression and trend curve is estimated.

Next at step 430, a ratio operation using the original data series and a trend curve is performed to provide a de-trended data series. The ratio operation has the effect of addressing seasonality and other components which can affect the forecast. Next at step 435, outliers remaining in the series are identified and removed after which financial cycle based seasonal factors are calculated. In certain embodiments, the financial cycle corresponds to financial quarters. Using the seasonal factors and the trend component, a first level estimated revenue forecast series is derived at step 438.

Next at step 440, to capture any recent impact and adjust for any change in trend, a weighted average of a certain number of previous quarter revenue is considered. In certain embodiments, the certain number corresponds to the previous four quarters. The weights are assigned based on the average error between current time period (e.g., quarter) revenue data and a plurality of previous time periods (e.g., quarters) revenue data. Thus, a second level estimated revenue forecast series is derived at step 445.

A rest to go (RTG) revenue prediction data is influenced by weeks to date (WTD) revenue data of the same quarter at step 450. For the purposes of this disclosure RTG represents a remaining portion of a particular time period (e.g., quarter) and WTD represents an already completed portion of the particular time period. Next, at step 455, a third level estimated revenue forecast series is derived by regressing the RTG revenue prediction data on the WTD revenue data.

At step 460, a final RTG revenue prediction value is obtained as a function of the first, second and third level estimated revenue forecast series. Individual regressions are performed on each of the three estimated revenue series. The final estimation is derived by taking a weighted average of the three level estimated revenue forecast series. In certain embodiments, the weights are assigned based on the average error gaps identified between each of the three revenue estimates and actual revenue values.

In certain embodiments, an antilogarithm of the predicted revenue is performed at step 465. Next, at step 470, a final RR revenue value is provided to various components within the forecasting environment after adjusting for business rules as agreed with the stakeholders. For example, if one of the hierarchies within the model has very limited/sparse revenue data points, then there is not much benefit to implement the regression approach. Instead, an average of a previous four quarters of actual RR Revenue for the specified RTG weeks is calculated to estimate the forecast for the hierarchy in question.

In various embodiments the forecast operation is coded and automated to function for all granular combinations. In certain embodiments, the output of the forecast operation is provided to and integrated with a business management system (BMS) (i.e., a central reporting system) for Predicted RTG RR Revenue in Pipeline Sufficiency reports.

Referring again to FIG. 3, the forecasting operation accounts for seasonality as well as actual revenue data that is specific to run rate deals. In certain embodiments, the forecasting operation incorporates the use of an advanced time series module that includes the influence of trend, seasonality and weekly patterns that are observed within the dataset.

In certain embodiments, at any given point in time, historical RR revenue data is limited to twelve previous quarters of data and the QTW (Quarter till Week) revenue attained in the current quarter. For example, if forecasting is being applied in the 6^{th} week of FY18Q1, the historical data of actual RR Revenue that is available is for the past twelve quarters (i.e. FY15Q1-FY 17Q4) and 01 to 05 weeks of the current quarter (i.e. FY18Q1).

In certain embodiments, the forecasting operation takes into account at least two variables, a rest to go (RTG) variable and a quarter till week (QTW) variable. Using these variables, the forecasting operation can obtain historical RR Revenue data that is divided into two categories before starting with the analysis. For example, if the business cycle is in the x^{th} week (x→Z & 1≤x≤12) of the current quarter, then: a QTW table which contains RR Revenue of all historical quarters (along with the present quarter) is obtained for weeks 1 to x. The QTW table would contain 13 quarters of data points and an RTG table which contains RR Revenue of all historical quarters obtained for weeks x to 13; the RTG table would contain 12 quarters of data point. The RR RTG revenue for current quarter (i.e., for weeks x+1 to 13) is the value that is to be predicted.

During an initial phase of the forecast operation, a plot of historical RR RTG Revenue vs. Time (in quarters) is charted at a granular level of Business Unit, Product Group Description, Line of Business etc.

Next a first level revenue estimate is calculated. More specifically, first level revenue estimate decomposes the RR RTG revenue based time series data into trend and seasonal components.

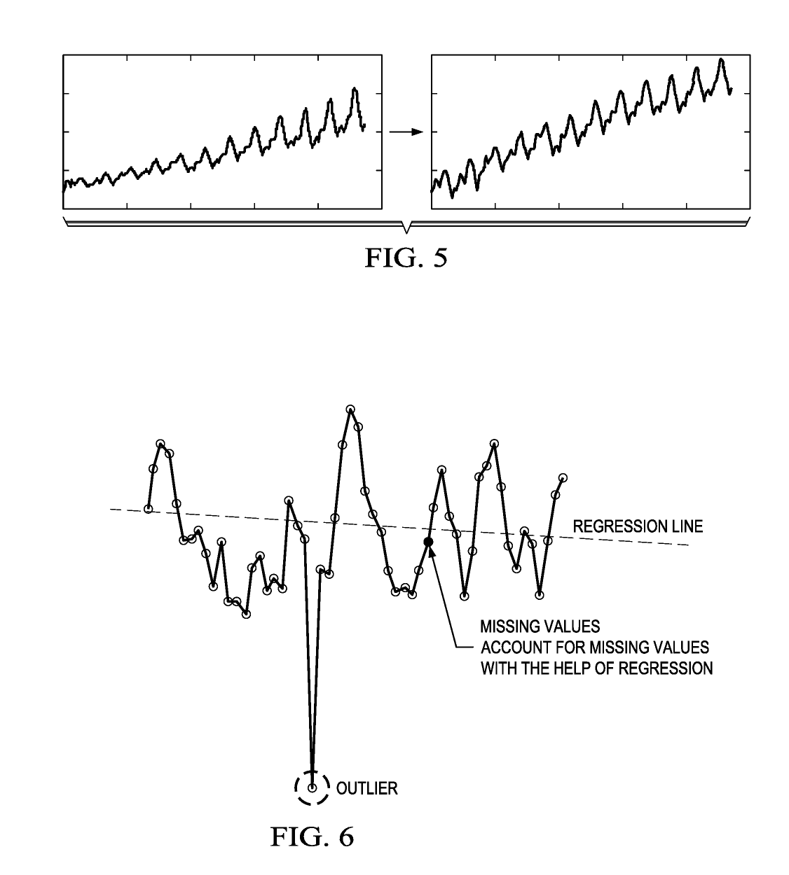

The forecasting operation identifies a field ‘ln(RR_RTG_Rev)’ and assigns logarithmic transformation values to ‘RR_RTG_Revenue’ column. The logarithmic transformation of the RR_RTG_Revenue value stabilizes any variance that exists in the raw data. FIG. 5 shows an example of the effect of the logarithmic transformation. Next, the forecasting operation creates a time field (t) and assigns values (1, 2, 3, . . . ) against a quarter column. For example, continuing the present example, the first quarter (Q1) of 2015 is assigned a value of t=1, the second quarter (Q2) of 2015 is assigned a values of t−2 and so on.

The forecasting operation then generates a flag field ‘flag_RTG’: The flag field is a binary field which assigns a value of 0 if the ‘log(RR_RTG_Rev)’ is un-defined i.e. if ‘RR_RTG_Revenue’ field contains 0 or negative data; else ‘flag_RTG’ is set to 1. More specifically, the flag field may be defined as:

$$flag\_RTG = \{ \begin{matrix}0 , & RR\_RTG \_Rev \leq 0 \\ 1 , & RR\_RTG \_Rev > 0\end{matrix}$$

The forecasting operation then generates a time adjusted field ‘t_adjusted’: The time adjusted field contains a value which is obtained by multiplying the columns ‘t’ and ‘flag_RTG’ for each row (representing respective quarters) in consideration when performing the forecasting operation.

The forecasting operation the generates an adjusted RTG revenue field ‘ln(RR_RTG_Rev)_adjusted’: The adjusted RTG revenue field contains a value which is obtained by multiplying the columns ‘ln(RR_RTG_Rev)’ and ‘flag_RTG’. If ‘ln(RR_RTG_Rev)’ column is undefined for a particular case (row), then the column takes a value of 0 as input. More specifically, the adjusted revenue field may be defined as:

$$ln ( RR\_RTG \_Rev ) \_adjusted = \{ \begin{matrix}0 , & RR\_RTG \_Rev \leq 0 \\ ln ( RR\_RTG \_Rev ) \times flag\_RTG , & RR\_RTG \_Rev > 0\end{matrix}$$

The forecasting operation then performs a linear regression operation with the dependent variable being ln(RR_RTG_Rev)_adjusted and the independent variables being t_adjusted and flag_RTG. The linear regression operation may be represented as:

ln(RR_RTG [symbol] )_adjusted=α+β×t_adjusted
where α=estimated intercept and β=estimated slope

The forecasting operation then generates a trend field ‘Trend_RTG’ and calculates the values for each quarter based on the Linear Regression outputs. The calculation may be defined as:

For t→Z&1≤t≤12

Trend_RTGₜ=α+β×t

The forecasting operation then uses the same calculation that was used to calculate values for each quarter to estimate the ‘Trend_RTG’ for future quarter or quarters (i.e. for t→Z & t≥13).

The forecasting operation then generates a de-trended series value ‘Detrended_Series_RTG’ based upon the ratio of ln(RR_RTG_REV) to Trend_RTG. This ratio may be defined as:

$$\frac{ln ( RR\_RTG \_Rev )}{Trend\_RTG}$$

The forecasting operation then calculates a quarterly average of the ratios. This function enables the forecasting operation to account for seasonal factors. This calculation for a given scenario may be defined as:

$$for i ∈ [ 1 , 4 ] \to Z$$

$$Seasonal factor for Qi = \frac{[ \begin{matrix}Detrended\_Series {\_RTG}_{2015 Qi} + \\ Detrended\_Series {\_RTG}_{2016 Qi} + Detrended\_Series {\_RTG}_{2017 Qi}\end{matrix} ]}{3}$$

The forecasting operation then calculates an outlier field ‘flag_detrended_RTG’. The outlier field identifies outliers using a box and whisker plot concept which defines an outlier as any value that lies more than one and a half times the length of the box from either end of the box. This field may be defined as:

Lower range: Quartile1−1.5×IQR

Upper range: Quartile3+1.5×IQR
where IQR represents an interquartile range which is the width of the box in the box-and-whisker plot

Thus, in the present example, IQR equals (Quartile3-Quartile1). When performing the forecasting operation the IQR provides a measure of how spread-out the ‘Detended_Series_RTG’ values are.

If the value of ‘Detrended_Series_RTG’ column lies between the lower range and upper range as defined, the value is not considered an outlier and the corresponding ‘flag_detrended_RTG’ column is assigned a value of FALSE; else TRUE. The flag_detrended_RTG column may be defined as:

$$flag\_detrended \_RTG = \{ \begin{matrix}FALSE , & ( Quartile 1 - 1.5 \times IQR ) \leq Detrended\_series \_RTG \leq ( Quartile 3 + 1.5 \times IQR ) \\ TRUE , & otherwise\end{matrix}$$

FIG. 6 shows an example of a result when statistical techniques are applied to identify and outliers and missing values.

The forecasting operation then calculates an adjusted de-trended field ‘Detrended_adjusted’. With the adjusted de-trended field if the value of ‘flag_detrended_RTG’ column is FALSE (i.e. the value is not an outlier), then the ‘Detrended_adjusted’ column takes the value of the ‘Detrended_Series_RTG’ column, else the column takes a value of 0.

With the values of Trend_RTG and the Seasonal Factors (for each quarter) obtained in the previous steps, the first level of revenue estimate is calculated. More specifically, the first level revenue estimate is calculated as:
For t→Z & t≥1; i denoting the quarter number for the particular row into consideration,

Rev_Estimate_L1ₜ=Trend_RTGₜ×Seasonal Factor for Qi
E.g. for 2018-Q1(where t=13 and i=1), Rev_Estimate_L1₁₃=Trend_RTG₁₃×Seasonal Factor for Q1
where Trend_RTG₁₃=α+β×t (t=13 in this case).

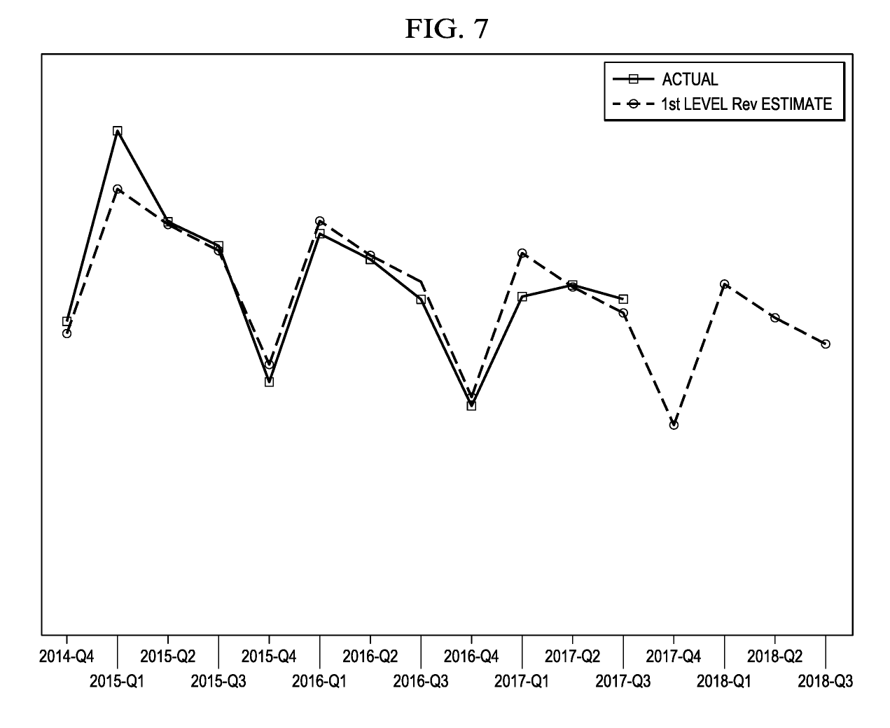

FIG. 7 shows an example of a first level of revenue forecast using the RR revenue forecasting model of the forecasting operation.

Next, a second level revenue estimate is calculated. More specifically, forecasting operation begins calculating a second level revenue estimate by identifying a plurality of lag fields. In certain embodiments, the lag fields correspond to a number of quarters of lag taken into consideration. Thus if four quarters of lag are taken into consideration, then the forecasting operation identifies for lag fields ‘ln(RR_RTG_Rev)_predicted_lag_iQ’ where i ∈ [1, 4]→Z i.e. i denotes the number of quarters of lag taken into consideration. For specific rows which have actuals data (i.e. RR_RTG_Rev has value) and i ∈ [1, 4]→Z, t ∈ [2, 12]→Z, the lag value is calculated as:

$$ln ( RR\_RTG \_Revenue ) \_predicted \_lag \_iQ for time period t \{ \begin{matrix}Rev\_Estimate \_L 1 for time period t - i , & \begin{matrix}if for time period t - i , ( t > i ) , \\ RR\_RTG \_Rev \leq 0 OR flag\_detrended \_RTG = TRUE\end{matrix} \\ ln ( RR\_RTG \_Rev ) for time period t - i , & otherwise\end{matrix}$$

Further the example, the ln(RR_RTG_Rev)_predicted_lag_2Q for t=5 will be ln(RR_RTG_Rev) for t=3 only if for t=3, RR_RTG_Rev >0 AND flag_detrended_RTG=FALSE, else the column takes the value of Rev_Estimate_L1 for t=3. The rows to be considered are those where there exists values in each of the four columns. More specifically, the rows to be considered are determined as follows:

ln(RR_RTG_Rev)_predicted_lag_iQ where i ∈ [1, 4]→Z

Thus, the first four rows are ignored (where t ∈ [1, 4]→Z).

The forecasting operation now calculates weightages for values stored within lag columns. More specifically, a Mean Absolute Percentage Error (MAPE) value is calculated for each of the four values of the quarterly lag columns for time period t ∈ [5, 12]→Z by comparing the quarterly lag values with the actuals (which correspond to ‘ln(RR_RTG_Rev)_adjusted’) of the corresponding quarter. Additionally, the reciprocal of the MAPE values for each of the four lag columns are calculated. More specifically, MAPE value for lag_{iQ} for time period t, where i ∈ [1, 4]→Z and t ∈ [5, 12]→Z is defined as:

$${MAPE}_{i} = \frac{1}{8} {\sum }_{t = 5}^{12} \vert \frac{\begin{matrix}[ ln ( RR\_RTG \_Rev ) \_predicted \_lag {\_iQ}_{t} ] - \\ [ ln ( RR\_RTG \_Rev ) {\_adjusted}_{t} ]\end{matrix}}{ln ( RR\_RTG \_Rev ) {\_adjusted}_{t}} \vert$$

The weightage of ln(RR_RTG_Rev)_predicted_lag_iQ is calculated as:

$$w ( {lag}_{i Q} ) = \frac{\frac{1}{{MAPE}_{i}}}{{\sum }_{i = 1}^{4} \frac{1}{{MAPE}_{i}}}$$

For the specific row(s) for which a prediction is desired, where i ∈ [1, 4]→Z, t→Z & t ≥13 is calculated as:

$$ln ( RR\_RTG \_Revenue ) \_predicted \_lag \_iQ for time period t \{ \begin{matrix}Rev\_Estimate \_L 1 for time period t - i , & \begin{matrix}if for time period t - i , \\ RR\_RTG \_Rev \leq 0\end{matrix} \\ ln ( RR\_RTG \_Rev ) for time period t - i , & otherwise\end{matrix}$$

With the values and the weightages of the four lag columns obtained as described above, the second level of revenue estimate is calculated. More specifically, the second level of revenue estimate may be calculated as:

$$For t \to Z \& t \geq 5$$

$$Rev\_Estimate \_L {2}_{t} = {\sum }_{i = 1}^{4} [ w ( {lag}_{iQ} ) \times ln ( RR\_RTG \_Rev ) \_predicted \_lag {\_iQ}_{t} ]$$

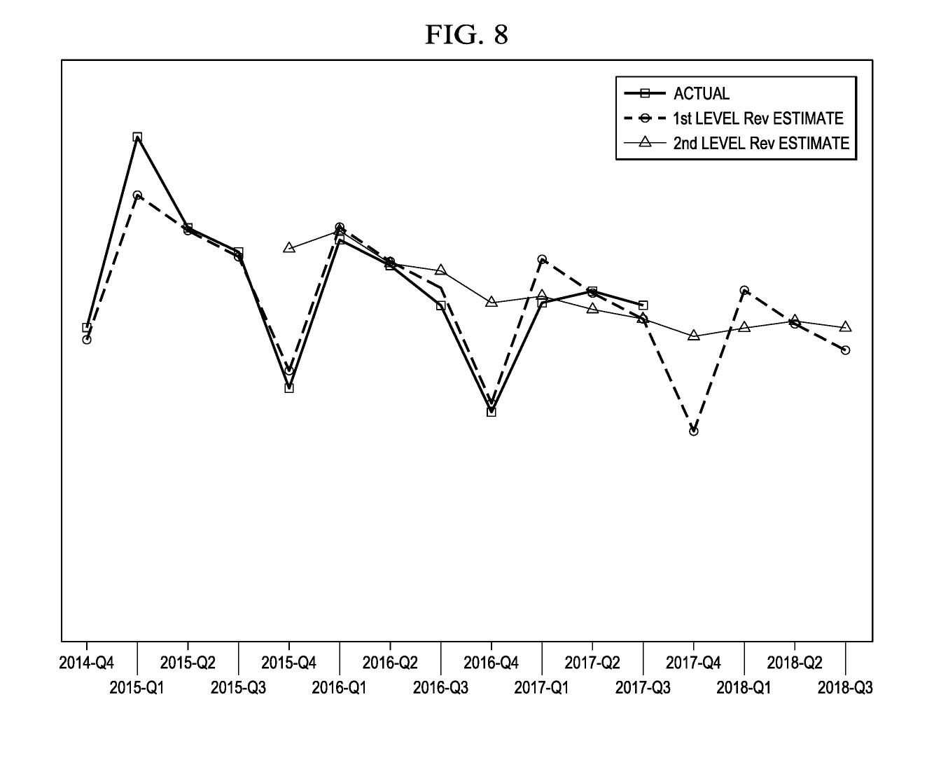

FIG. 8 shows an example of a second level of revenue forecast using the RR revenue forecasting model of the forecasting operation.

Next a third level revenue estimate is calculated. More specifically, the forecasting operation begins calculating the third level revenue estimate by decomposing RR QTW revenue based time series data into trend and seasonal components.

Next, the forecasting operation identifies a run rate quarter till week revenue field ‘ln(RR_QTW_Rev)’: The forecasting operation then uses the quarter to week revenue field to assign logarithmic transformation values on a ‘RR_QTW_Revenue’ column. The forecasting operation then identifies a time field ‘t’ and assign values (1, 2, 3 . . . ) against the Quarter column. Continuing the present example, Quarter 2015-Q1 is assigned a value of t=1 and so on.

The forecasting operation then identifies a quarter till week flag field ‘flag_QTW’. The quarter till week flag field is a binary field which assigns a value of 0 if the ‘log(RR_QTW_Rev)’ is un-defined i.e. if ‘RR_QTW_Revenue’ field contains 0 or negative data; else ‘flag_QTW’ is set to 1. More specifically, the quarter till week flag field may be defined as:

$$flag\_QTW = \{ \begin{matrix}0 , & RR\_QTW \_Rev \leq 0 \\ 1 , & RR\_QTW \_Rev > 0\end{matrix}$$

Next, the forecasting operation identifies an adjusted time field ‘t_adjusted’. The values for adjusted time field is obtained by multiplying the columns ‘t’ and ‘flag_QTW’ for each row (representing respective quarters) in consideration. The forecasting operation then identifies an adjusted run rate quarter till week field ‘ln(RR_QTW_Rev)_adjusted’. The value of the adjusted run rate quarter till week is obtained by multiplying the columns ‘ln(RR_QTW_Rev)’ and ‘flag_QTW’; if ‘ln(RR_QTW_Rev)’ column is undefined for a particular case (row), then the column takes a value of 0 as input. More specifically, the adjusted run rate quarter till week is defined as:

$$ln ( RR\_QTW \_Rev ) \_adjusted = \{ \begin{matrix}0 , & RR\_QTW \_Rev \leq 0 \\ ln ( RR\_QTW \_Rev ) \times flag\_QTW , & RR\_QTW \_Rev > 0\end{matrix}$$

The forecasting operation then performs a linear regression operation with the dependent variable being ln(RR_QTW_Rev)_adjusted and the independent variables being t_adjusted and flag_QTW. The linear regression operation may be represented as:

ln(RR_QTW_ [symbol] )_adjusted=α+β×t_adjusted
where α=estimated intercept and β=estimated slope.

The forecasting operation then generates a trend field ‘Trend_QTW and calculate the values for each quarter based on the Linear Regression outputs. The calculation may be defined as:

For t→Z&1≤t≤12

Trend_QTWₜ=α+β×t

The forecasting operation then uses the same calculation that was used to calculate values for each quarter to estimate the ‘Trend_QTW’ for future quarter or quarters, e.g., for t→Z & t≥13.

The forecasting operation then generates a de-trended series field ‘Detrended_Series_QTW’ by computing the ratio of ln(RR_QTW_Rev) to Trend_QTW. Next the forecasting operation calculates a quarterly average of the rations to account for seasonality factors. More specifically, the seasonality factors may be defined as follows:

$$Seasonal factor for Q 1 = \frac{[ \begin{matrix}Detrended\_Series {\_QTW}_{2015 Q 1} + Detrended\_Series {\_QTW}_{2016 Q 1} + \\ Detrended\_Series {\_QTW}_{2017 Q 1} + Detrended\_Series {\_QTW}_{2018 Q 1}\end{matrix} ]}{4}$$

$$Seasonal factor for Q 2 = \frac{[ \begin{matrix}Detrended\_Series {\_QTW}_{2015 Q 2} + Detrended\_Series {\_QTW}_{2016 Q 2} + \\ Detrended\_Series {\_QTW}_{2017 Q 2}\end{matrix} ]}{3}$$

$$Seasonal factor for Q 3 = \frac{[ \begin{matrix}Detrended\_Series {\_QTW}_{2015 Q 3} + Detrended\_Series {\_QTW}_{2016 Q 3} + \\ Detrended\_Series {\_QTW}_{2017 Q 3}\end{matrix} ]}{3}$$

$$Seasonal factor for Q 4 = \frac{[ \begin{matrix}Detrended\_Series {\_QTW}_{2015 Q 4} + Detrended\_Series {\_QTW}_{2016 Q 4} + \\ Detrended\_Series {\_QTW}_{2017 Q 4}\end{matrix} ]}{3}$$

The forecasting operation then identifies a flag de-trended QTW field. Calculate new field ‘flag_detrended_QTW’ to identify outliers using the box and whisker plot concept which states an outlier is any value that lies more than one and a half times the length of the box from either end of the box. More specifically, the box and whisker plot concept may be defined as:

Lower range: Quartile1−1.5×IQR

Upper range: Quartile3+1.5×IQR
where the interquartile range (IQR), is the width of the box in the box-and-whisker plot. i.e., IQR=Quartile3−Quartile1. The IQR is used as a measure of how spread-out the values are.

If the value of ‘Detrended_Series_QTW’ column lies between the lower range and upper range (as defined), the value is not considered an outlier and the corresponding ‘flag_detrended_QTW’ column is assigned a value of FALSE; else TRUE. I.e., the flag detrended QTW value may be defined as:

$$flag\_detrended \_QTW = \{ \begin{matrix}FALSE , & ( Quartile 1 - 1.5 \times IQR ) \leq Detrended\_Series \_QTW \leq ( Quartile 3 + 1.5 \times IQR ) \\ TRUE , & otherwise\end{matrix}$$

The forecasting operation then defines a field ‘Detrended_adjusted’: If the value of ‘flag_detrended_QTW’ column is FALSE (i.e. not an outlier), then the ‘Detrended_adjusted’ column takes the value of ‘Detrended_Series_QTW’ column, else 0. The forecasting operation then uses the back trend and seasonal component to perform the prediction. More specifically, the forecasting operation identifies a QTW predicted field ‘ln(RR_QTW_Rev)_predicted.’
The QTW predicted field may be defined as:

ln(RR_QTW_Rev)_predicted=Trend×Seasonal Factor
E.g. for 2017-Q1 (where t=9 and i=1), Rev_Estimate_L1₉=Trend_RTG₉×Seasonal Factor for Q1
where Trend_RTG₉=α+β×t (t=9 in this case)

The forecasting operation then defines a flag adjusted field ‘flag_adj.’ The flag adjusted field may be defined as:

flag_adjₜ=flag_QTWₜ×flag_RTGₜ
where flag_RTGₜ is obtained from previous scenarios for the same time period t.

The forecasting operation then defines a run rate QTW predicted field ‘ln(RR_QTW_Rev)_predicted_lr.’ The run rate QTW predicted field may be defined as:

$$For the specific row ( s ) which need to be predicted , where t ∈ [ 1 , 13 ] \to Z$$

$$ln ( RR\_QTW \_Revenue ) \_predicted \_lr for time period t \{ \begin{matrix}\begin{matrix}[ ln ( RR\_QTW \_Rev ) \_predicted for time period t ] \times \\ [ flag\_adj for time period t ] ,\end{matrix} & \begin{matrix}if for time period t , RR\_QTW \_Rev \leq 0 OR \\ flag\_adj for time period t = TRUE\end{matrix} \\ \begin{matrix}[ ln ( RR\_QTW \_Rev ) for time period t ] \times \\ [ flag\_adj for time period t ] ,\end{matrix} & otherwise\end{matrix}$$

The forecasting operation then re-aligns the column ‘ln(RR_RTG_Rev)_adjusted’ obtained in earlier steps with respect to time period t. The forecasting operation then identifies a run rate RTG predicted field ‘ln(RR_RTG_Rev)_predicted_lr.’ The run rate RTG predicted field may be defined as:
For the specific row(s) which need to be predicted, where t ∈ [1, 12]→Z

ln(RR_RTG_Rev)_predicted_lrₜ=flag_adjₜ×ln(RR_RTG_Rev)_adjustedₜ

The forecasting operation then defines a run rate QTW predicted compute field ‘ln(RR_QTW_Rev)_predicted_compute’ The run rate QTW predicted compute field may be defined as:

$$For the specific rows which have actuals data ( i . e . column RR\_QTW \_Rev has value ) and t ∈ [ 1 , 12 ] \to Z$$

$$ln ( RR\_QTW \_Revenue ) \_predicted \_compute for time period t \{ \begin{matrix}ln ( RR\_QTW \_Rev ) \_predicted for time period t , & \begin{matrix}if for time period t , RR\_QTW \_Rev \leq 0 OR \\ flag\_adj for time period t = TRUE\end{matrix} \\ ln ( RR\_QTW \_Rev ) for time period t , & otherwise\end{matrix} \\ For the specific row ( s ) which need to be predicted , where t \to Z \& t \geq 13 , \\ ln ( RR\_QTW \_Revenue ) \_predicted \_compute for time period t \{ \begin{matrix}ln ( RR\_QTW \_Rev ) \_predicted for time period t , & if for time period t , RR QTW Rev \leq 0 \\ ln ( RR\_QTW \_Rev ) for time period t , & otherwise\end{matrix}$$

The forecasting operation then performs a linear regression with:

Dependent variable: ln(RR_RTG_Rev)_predicted_lr

Independent variable: flag_adj and ln(RR_QTW_Rev)_predicted_lr

ln(RR_RTG_ [symbol] )_predicted_lr=α+β×ln(RR_QTW_Rev)_predicted_lr
We get the values α and β where α=estimated intercept and β=estimated slope

The forecasting operation then calculates a third level revenue estimate. More specifically, the forecasting operation uses the previously obtained regression components to calculate the third level revenue estimate. More specifically, the third level revenue estimate may be defined as:

For t→Z & t≥1

Rev_Estimate_L3ₜ=β×[ln(RR_QTW_Rev)_predicted_compute]ₜ+α

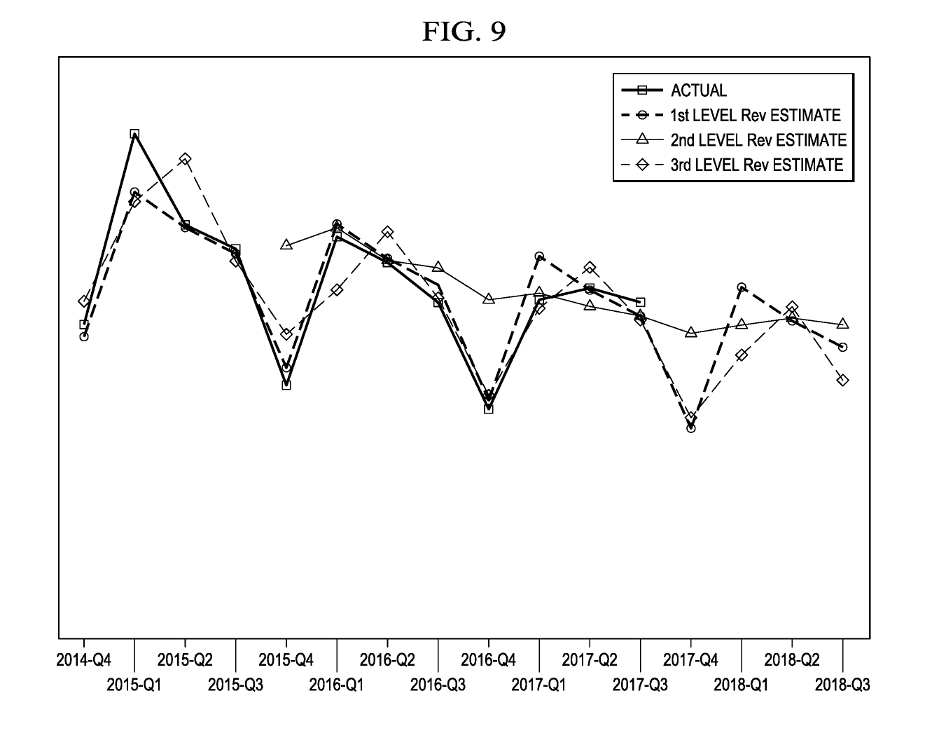

FIG. 9 shows an example of a third level revenue estimate using the run rate revenue forecasting model.

Next, the forecasting operation uses the first, second and third level run rate revenue forecasts to identify a final run rate revenue forecast. More specifically, a Mean Absolute Percentage Error (MAPE) value is calculated for each of the three revenue estimate levels for a time period t ∈[5, 12]→Z by comparing the estimates with the actuals (which in this case, is stored as ‘ln(RR_RTG_Rev)_adjusted’) of the corresponding quarter. Next, the reciprocal of the MAPE values for each of the three revenue estimates columns are calculated as MAPE for Rev_Estimate_Lx for time period t, where x ∈ [1, 3]→Z and t ∈ [5, 12]→Z

$${MAPE}_{x} = \frac{1}{8} {\sum }_{t = 5}^{12} \vert \frac{[ Rev\_Estimate {\_Lx}_{t} ] - [ ln ( RR\_RTG \_Rev ) {\_adjusted}_{t} ]}{ln ( RR\_RTG \_Rev ) {\_adjusted}_{t}} \vert$$

Weightage of Rev_Estimate_Lx i.e.

$$w ( Rev\_Estimate \_Lx ) = \frac{\frac{1}{{MAPE}_{x}}}{{\sum }_{x = 1}^{3} \frac{1}{{MAPE}_{x}}}$$

With the values and the weightages of the three Revenue Estimate columns obtained, the forecasting operation predicts for the future time period as:
For t→Z & t≥13

Rev_Forecastₜ=eΣₓ₌₁³]w(Rev_Estimate_Lx)×Rev_Estimate_Lxₜ]

A final RTG Revenue prediction is obtained from the weighted average of all three revenue estimates taken together. The weights assigned to the three revenue estimates are determined based on the ratio of the reciprocal of Mean Absolute Percentage Error (MAPE) of each revenue estimate with the actual dataset.

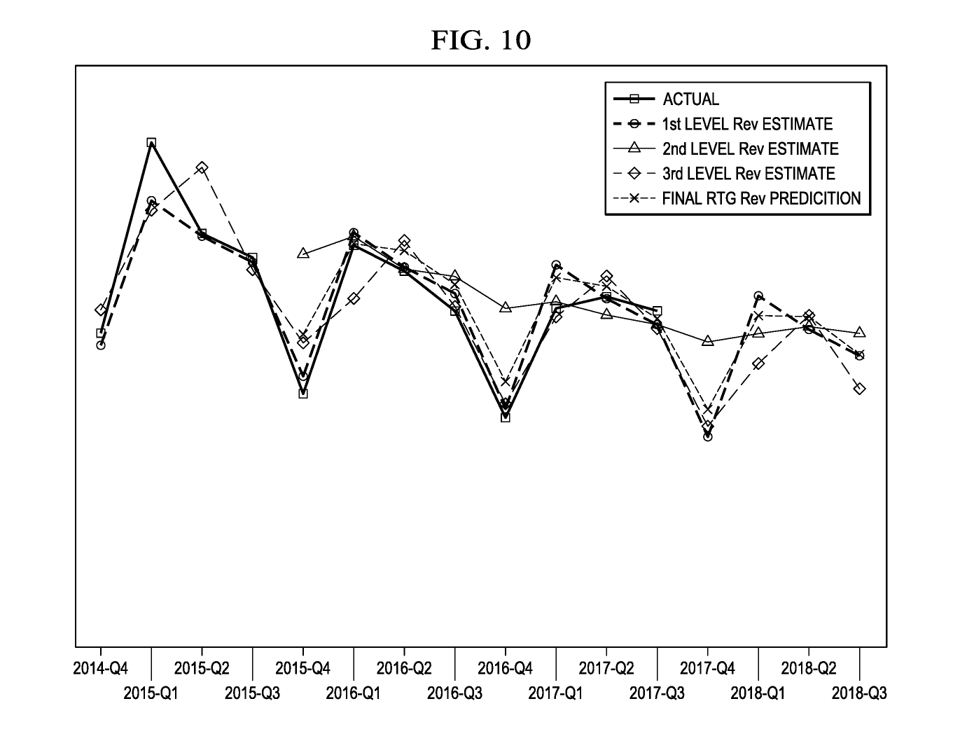

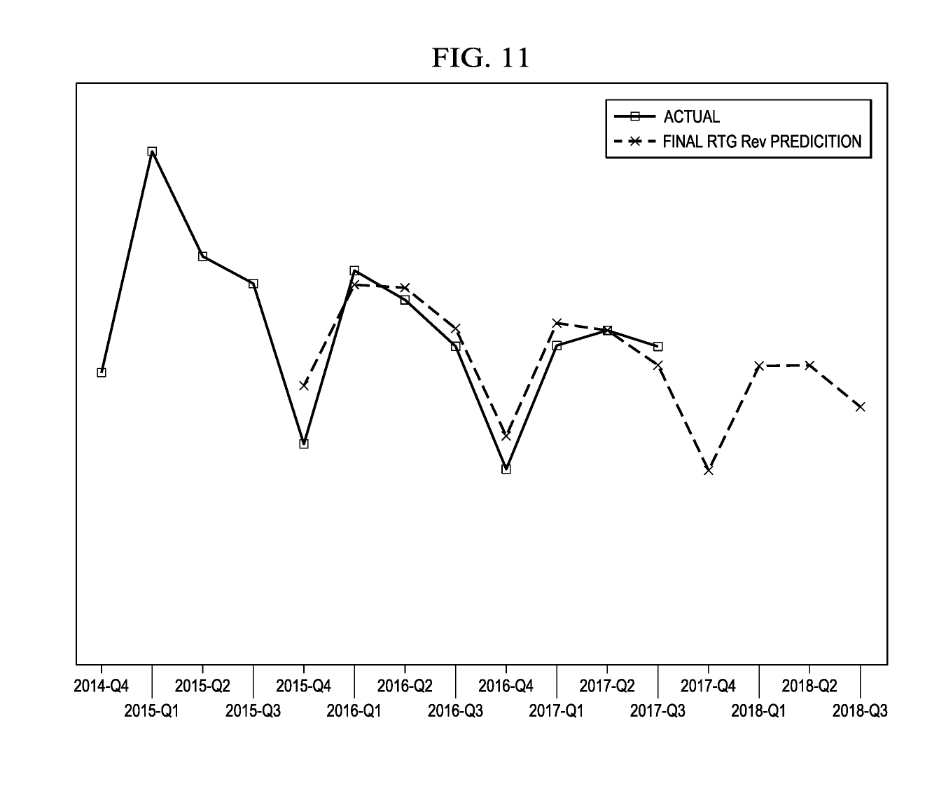

FIG. 10 shows an example of a final prediction using the run rate revenue forecasting model. In certain embodiments the final prediction may be adjusted based upon certain business rules such as a comparison of the final run rate prediction vs. actuals where the final prediction is applied to certain business sub entities. FIG. 11 shows an example of a comparison of the final run rate prediction vs. actuals data.

In certain embodiments, the information obtained via the forecasting operation may be presented via a tracking user interface. The tracking user interface provides a pipeline sufficiency metric. The pipeline sufficiency metric provides information regarding how sufficient a sales pipeline is in a given week to meet predefined targets. This information may then be used for a variety of business decisions including but not limited to managing obtaining inventory and manufacturing and/or configuration products such as information handling systems.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for manufacturing and configuring an information handling system, comprising:
generating a first level forecast prediction, the first level forecast prediction being based upon seasonal factors and a trend component;
generating a second level forecast prediction, the second level forecast prediction being based upon an average error between current time period revenue data and a plurality of previous time periods revenue data;
generating a third level forecast prediction, the third level forecast prediction being based upon a remaining portion of a particular time period and data relating to an already completed portion of the particular time period;
generating a final forecast prediction, the final forecast prediction being based upon the first level forecast prediction, the second level forecast prediction and the third level forecast prediction; and,
adjusting inventory used for manufacturing and configuring the information handling system based upon the final forecast prediction.

2. The method of claim 1, wherein:
generating the final forecast further comprises assigning weights from individual prediction errors when arriving at the final forecast prediction.

3. The method of claim 1, wherein:
when generating the first level forecast prediction, data used to generate the first level forecast prediction is formatted at time series data and is separated at a granular level.

4. The method of claim 1, wherein:
when generating the second level forecast prediction, a weighted average of a certain number of previous quarter revenue is considered and weights are assigned based on the average error between current quarter revenue data and each of the previous quarters revenue data.

5. The method of claim 1, wherein:
when generating the third level forecast prediction, a third level estimated revenue forecast series is derived by regressing the remaining portion of the particular time period on the data relating to the already completed portion of the particular time period.

6. The method of claim 1, wherein:
when generating the final forecast prediction, individual regressions are performed on each of the first level forecast prediction, the second level forecast prediction and the third level forecast prediction;
a final estimation is derived by taking a weighted average of each of the first level forecast prediction, the second level forecast prediction and the third level forecast prediction of each of the first level forecast prediction, the second level forecast prediction and the third level forecast predictions; and,
weights of the weighted average are assigned based on the average error from individual regressions.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
generating a first level forecast prediction, the first level forecast prediction being based upon seasonal factors and a trend component;
generating a second level forecast prediction, the second level forecast prediction being based upon an average error between current time period revenue data and a plurality of previous time periods revenue data;
generating a third level forecast prediction, the third level forecast prediction being based upon a remaining portion of a particular time period and data relating to an already completed portion of the particular time period;
generating a final forecast prediction, the final forecast prediction being based upon the first level forecast prediction, the second level forecast prediction and the third level forecast prediction; and,
adjusting inventory used for manufacturing and configuring the information handling system based upon the final forecast prediction.

8. The system of claim 7, wherein:
generating the final forecast further comprises assigning weights from individual prediction errors when arrive at the final forecast prediction.

9. The system of claim 7, wherein:
when generating the first level forecast prediction, data used to generate the first level forecast prediction is formatted at time series data and is separated at a granular level.

10. The system of claim 7, wherein:
when generating the second level forecast prediction, a weighted average of a certain number of previous quarter revenue is considered and weights are assigned based on the average error between current quarter revenue data and each of the previous quarters revenue data.

11. The system of claim 7, wherein:
when generating the third level forecast prediction, a third level estimated revenue forecast series is derived by regressing the remaining portion of the particular time period one the data relating to the already completed portion of the particular time period.

12. The system of claim 7, wherein:
when generating the final forecast prediction, individual regressions are performed on each of the first level forecast prediction, the second level forecast prediction and the third level forecast prediction;
a final estimation is derived by taking a weighted average of each of the first level forecast prediction, the second level forecast prediction and the third level forecast prediction of each of the first level forecast prediction, the second level forecast prediction and the third level forecast predictions; and,
weights of the weighted average are assigned based on the average error from individual regressions.

13. A non-transitory, computer-readable storage medium embodying computer program code, the computer program code comprising computer executable instructions configured for:
generating a first level forecast prediction, the first level forecast prediction being based upon seasonal factors and a trend component;
generating a second level forecast prediction, the second level forecast prediction being based upon an average error between current time period revenue data and a plurality of previous time periods revenue data;
generating a third level forecast prediction, the third level forecast prediction being based upon a remaining portion of a particular time period and data relating to an already completed portion of the particular time period;
generating a final forecast prediction, the final forecast prediction being based upon the first level forecast prediction, the second level forecast prediction and the third level forecast prediction; and,
adjusting inventory used for manufacturing and configuring the information handling system based upon the final forecast prediction.

14. The non-transitory, computer-readable storage medium of claim 13, wherein:
generating the final forecast further comprises assigning weights from individual prediction errors when arrive at the final forecast prediction.

15. The non-transitory, computer-readable storage medium of claim 13, wherein:
when generating the first level forecast prediction, data used to generate the first level forecast prediction is formatted at time series data and is separated at a granular level.

16. The non-transitory, computer-readable storage medium of claim 13, wherein:
when generating the second level forecast prediction, a weighted average of a certain number of previous quarter revenue is considered and weights are assigned based on the average error between current quarter revenue data and each of the previous quarters revenue data.

17. The non-transitory, computer-readable storage medium of claim 13, wherein:
when generating the third level forecast prediction, a third level estimated revenue forecast series is derived by regressing the remaining portion of the particular time period one the data relating to the already completed portion of the particular time period.

18. The non-transitory, computer-readable storage medium of claim 13, wherein:
when generating the final forecast prediction, individual regressions are performed on each of the first level forecast prediction, the second level forecast prediction and the third level forecast prediction;
a final estimation is derived by taking a weighted average of each of the first level forecast prediction, the second level forecast prediction and the third level forecast prediction of each of the first level forecast prediction, the second level forecast prediction and the third level forecast predictions; and,
weights of the weighted average are assigned based on the average error from individual regressions.
